(19) United States
(12) Patent Application Publication
(10) Pub. No.: US 2020/0399938 A1
(43) Pub. Date: Dec. 24, 2020

(54) Locking Device Having No Restriction on Order of Opening or Closing Door

(71) Applicants: Hyundai Motor Company, Seoul (KR); Kia Motors Corporation, Seoul (KR); Pyeong Hwa Automotive Co., Ltd., Daegu (KR)

(72) Inventors: Chi-Young Min, Bucheon-si (KR); Min-Ho Kim, Anyang-si (KR); Jae-Kyu Lee, Gunpo-si (KR); Ki-Ryun Ahn, Daegu (KR); Hyun-Duk Cho, Daegu (KR); Seong-Geon Byeon, Daegu (KR)

(21) Appl. No.: 16/686,964

(22) Filed: Nov. 18, 2019

(30) Foreign Application Priority Data
Jun. 21, 2019 (KR) 10-2019-0074335

(51) Int. Cl. E05B 83/38; E05B 85/04; E05B 85/24; E05B 85/26; E05B 79/20; E05B 77/38; E05B 15/04; B60J 5/04

(52) U.S. Cl. CPC E05B 83/38; E05B 85/045; E05B 85/243; E05B 85/26; E05Y 2900/531; E05B 77/38; E05B 15/04; B60J 5/0479; E05B 79/20

(57) ABSTRACT

A locking device for a door includes a first latch unit including a catching unit positioned at a lateral side of the first door and rotatably coupled to a first plate, a pawl unit rotatably coupled to the first plate to rotate the catching unit or restrict the rotation of the catching unit, and a first release lever configured to assist in rotating the pawl unit about a rotating shaft for the pawl unit. A second latch unit is positioned at a lateral side of the second door so as to face the first latch unit and includes a second release lever rotatably coupled to a second plate, and a striker unit configured to be caught by or released from the rotating catching unit.

### CROSS-REFERENCE TO RELATED APPLICATIONS

This application claims priority to Korean Patent Application No. 10-2019-0074335, filed in the Korean Intellectual Property Office on Jun. 21, 2019, which application is hereby incorporated herein by reference.

### TECHNICAL FIELD

The present invention relates to a locking device having no restriction on order of opening or closing doors mounted on a vehicle.

### BACKGROUND

In general, a vehicle has an occupant compartment having a predetermined size so that a driver or an accompanied occupant may be seated therein, and occupant compartment opening/closing doors are installed on a vehicle body to open or close the occupant compartment.

In the case of a passenger vehicle, the occupant compartment opening/closing doors include a front door installed at a front side in a longitudinal direction of the vehicle and a rear door installed at a rear side in the longitudinal direction of the vehicle. The front door and the rear door are typically installed on the vehicle body so as to be rotatable by means of hinges.

Recently, a B-pillarless door, from which a B-pillar is removed, is used to increase an open space of the occupant compartment to make it easy to load articles and improve conditions that allow occupants to get in or out of a narrow space.

In general, the B-pillar is installed to protect safety of a passenger due to providing rigidity in respect to a broadside collision of a vehicle. In order to manufacture the B-pillarless door, it is necessary that the front and rear doors are not damaged nor opened by impact applied to a lateral side of the vehicle.

In this regard, Korean Patent No. 10-1199223 (Locking Device for Front Door for B-Pillarless Vehicle) in the related art discloses a locking device for a door including: an upper end latch unit provided at an inner upper end of a front door and configured to be caught by or released from an upper end striker; a lower end latch unit provided at an inner lower end of the front door and configured to be caught by or released from a lower end striker; and a drive unit provided inside the front door and configured to operate the upper end latch unit and the lower end latch unit so that the upper end latch unit and the lower end latch unit are caught by or released from the upper end striker and the lower end striker, respectively, in accordance with an unlocked or locked mode between a safety knob and a key, in which the upper end latch unit and the lower end latch unit are simultaneously controlled to open or close the front door in accordance with the unlocked or locked mode between the safety knob and the key.

However, Korean Patent No. 10-1199223 just discloses a technology for more assuredly locking the front door to the vehicle body, but discloses no solution in respect to the rear door.

The order of opening or closing the front and rear doors is sometimes predetermined depending on the vehicle. For example, regarding the order of opening or closing the doors, the front door is opened first and the rear door is then opened when opening the doors, and the rear door is closed first and the front door is then closed when closing the doors.

### SUMMARY

The present invention relates to a locking device having no restriction on order of opening or closing doors mounted on a vehicle. Particular embodiments relate to a locking device having no restriction on order of opening or closing doors. The locking device is capable of locking or unlocking front and rear doors connected to a vehicle body, and opening any one of the front and rear doors first in a state in which the front and rear doors are closed and locked, or closing any one of the front and rear doors first in a state in which the front and rear doors are unlocked and opened.

[soon] Embodiments of the present invention can provide a locking device having a new structure capable of locking or unlocking front and rear doors by connecting the front and rear doors and capable of opening or closing the front or rear door regardless of the order of opening or closing the front and rear doors.

An exemplary embodiment of the present invention provides a locking device having no restriction on order of opening or closing doors, which is capable of locking or unlocking first and second doors connected to a vehicle body, and opening any one of the first and second doors first in a state in which the doors are closed and locked or closing any one of the first and second doors first in a state in which the doors are unlocked and opened. The locking device includes a first latch unit including a catching unit positioned at a lateral side of the first door and rotatably coupled to a first plate, a pawl unit rotatably coupled to the first plate to rotate the catching unit or restrict the rotation of the catching unit, and a first release lever configured to assist in rotating the pawl unit about a rotating shaft for the pawl unit. A second latch unit is positioned at a lateral side of the second door so as to face the first latch unit and includes a second release lever rotatably coupled to a second plate, and a striker unit configured to be caught by or released from the rotating catching unit.

According to the present invention, any one of the first and second doors may be opened by separate operations of the locking device without restriction on the order of opening the doors, and as a result, there is no restriction on the order of opening the doors.

According to the present invention, the first latch unit and the second latch unit may be maintained in the fastened state when closing the doors, and as a result, it is possible to prevent the doors from being opened and damaged.

According to the present invention, a method of locking or unlocking the first and second doors with respect to each other is used instead of a method of locking or unlocking the first and second doors with respect to the vehicle body, and as a result, the number of components is reduced.

### BRIEF DESCRIPTION OF THE DRAWINGS

FIG. 1 is a view illustrating a state in which a first latch unit and a second latch unit according to an exemplary embodiment of the present invention are mounted on a first door and a second door, respectively.

FIG. 2 is a perspective view illustrating the first latch unit illustrated in FIG. 1.

FIG. 3 is an exploded perspective view illustrating a state in which the first latch unit illustrated in FIG. 2 is disassembled.

FIG. 4 is a view illustrating a catching unit according to the exemplary embodiment of the present invention.

FIG. 5 is a perspective view illustrating the second latch unit illustrated in FIG. 1.

FIG. 6 is an exploded perspective view illustrating a state in which the second latch unit illustrated in FIG. 4 is disassembled.

FIG. 7A is a view illustrating an operation of releasing the locking device by pulling a cable connected to the first latch unit, and FIG. 7B is a view illustrating a state in which the first latch unit and the second latch unit are separated from each other after the locking device is released.

FIG. 8A is a view illustrating an operation of releasing the locking device by pulling the cable connected to the second latch unit, and FIG. 8B is a view illustrating a state in which the first latch unit and the second latch unit are separated from each other after the locking device is released.

### DETAILED DESCRIPTION OF ILLUSTRATIVE EMBODIMENTS

Hereinafter, exemplary embodiments of a locking device having no restriction on order of opening or closing doors according to the present invention will be described in detail with reference to the drawings. Terms or words used herein should not be interpreted as being limited to a general or dictionary meaning and should be interpreted as a meaning and a concept which conform to the technical spirit of the present invention based on a principle that an inventor can appropriately define a concept of a term in order to describe his/her own invention by the best method.

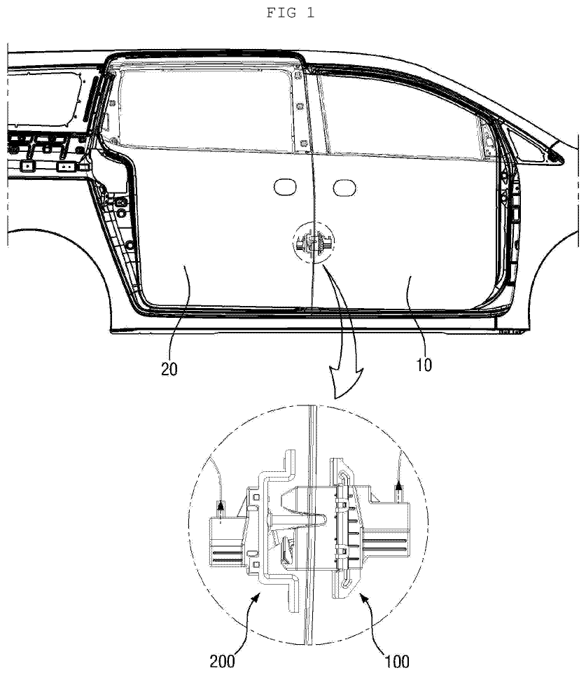

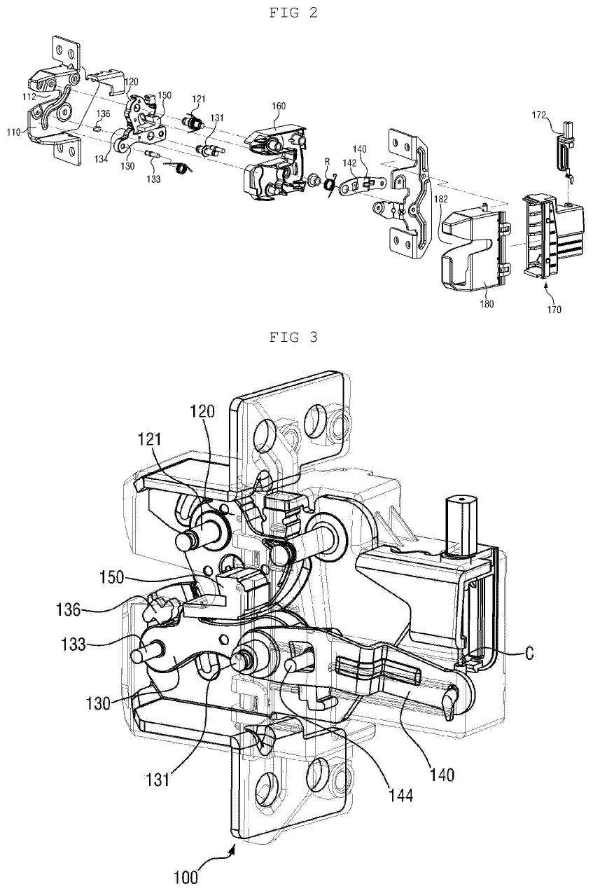

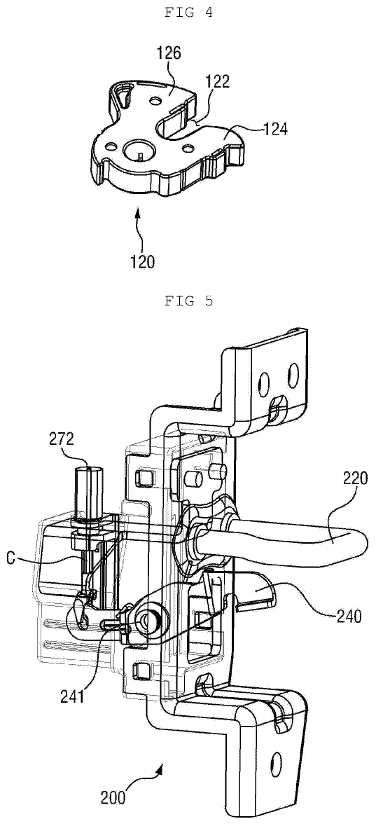

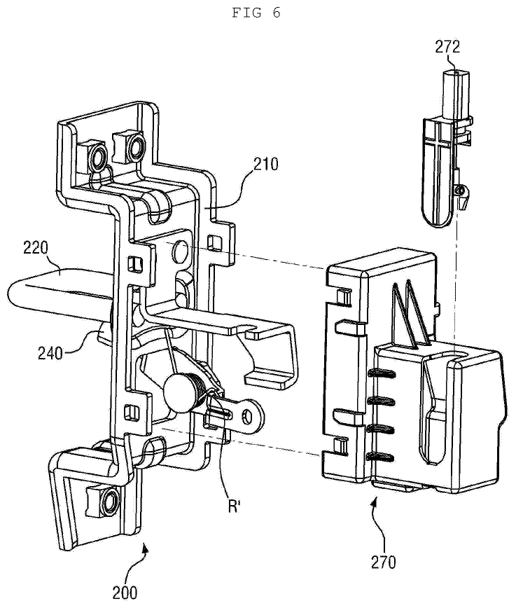

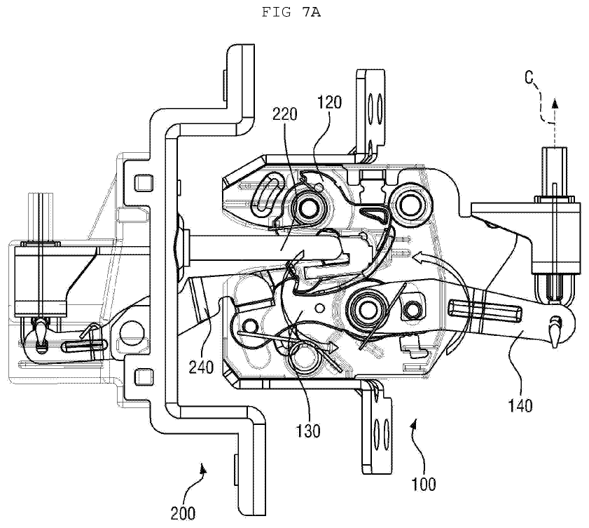

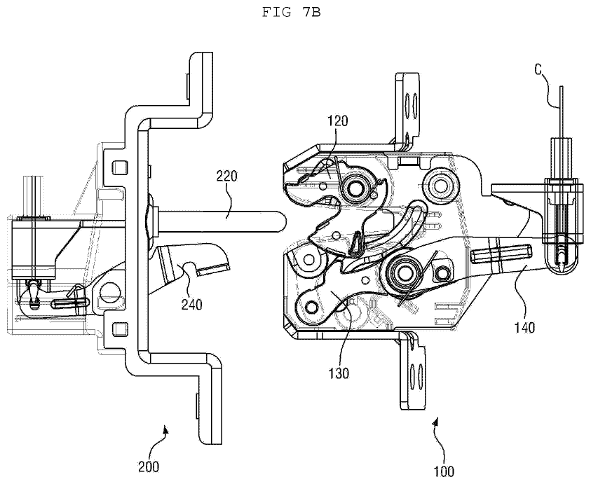

FIG. 1 is a view illustrating a state in which a first latch unit and a second latch unit according to an exemplary embodiment of the present invention are mounted on a first door and a second door, respectively, FIG. 2 is a perspective view illustrating the first latch unit illustrated in FIG. 1, FIG. 3 is an exploded perspective view illustrating a state in which the first latch unit illustrated in FIG. 2 is disassembled, FIG. 4 is a view illustrating a catching unit according to the exemplary embodiment of the present invention, FIG. 5 is a perspective view illustrating the second latch unit illustrated in FIG. 1, and FIG. 6 is an exploded perspective view illustrating a state in which the second latch unit illustrated in FIG. 5 is disassembled.

Referring to FIGS. 1 to 6, the locking device having no restriction on order of opening or closing doors according to the exemplary embodiment of the present invention is configured to lock and unlock doors coupled to a B-pillarless vehicle body, and the locking device includes a first latch unit 100 and a second latch unit 200. Here, the first latch unit 100 is positioned inside a first door 10, and the second latch unit 200 is positioned inside the second door 20. In the present specification, based on the vehicle body, the first door 10 is positioned at a front side and the second door 20 is positioned at a rear side, but the positions of the first and second doors 10 and 20 are not restricted.

According to the exemplary embodiment of the present invention, the first and second doors 10 and 20 are coupled to the vehicle body so as to be slidable in a direction in which the first and second doors 10 and 20 face each other or are spaced apart from each other. However, in another exemplary embodiment of the present invention, the first door (regular door) 10 may be swingably connected to the vehicle body, and the second door 20 may be slidably connected to the vehicle body, and vice versa. The first and second doors 10 and 20 may be swingably connected to the vehicle body. However, regardless of types of door structures, the locking device according to the present invention may be applied to the structure of the vehicle body having no B-pillar.

The first latch unit 100 and the second latch unit 200 are connected while facing each other at opposite positions when the first door 10 and the second door 20 are closed. Therefore, the first latch unit 100 is positioned at a lateral side of the first door 10, and the second latch unit 200 is positioned at a lateral side of the second door 20 so as to face the first latch unit 100.

The first latch unit 100 includes a first plate no having a bracket portion so as to be mounted on the first door 10, a catching unit 120 connected to the first plate 110, a pawl unit 130, and a first release lever 140.

As illustrated in FIGS. 2 and 3, the catching unit 120 is connected to the first plate no so as to be rotatable about a catching unit rotating shaft 121. Here, the catching unit rotating shaft 121 is fixedly connected to the first plate 110. The catching unit 120 includes an accommodating groove 122, a catching portion 124 formed at one side of the accommodating groove 122, and a weight portion 126 formed at the other side of the accommodating groove 122.

The accommodating groove 122 is recessed toward the inside of the catching unit 120 and configured to accommodate the striker unit 220 to be described below, and the accommodating groove 122 has a shape corresponding to a shape of the striker unit 220. Therefore, a rotational region of the catching unit 120 includes a region in which the accommodating groove 122 faces the striker unit 220.

Meanwhile, the first plate 110 includes a plate insertion groove 112 having a shape corresponding to the shape of the striker unit 220 so that the striker unit 220 may be accommodated in the accommodating groove 122 of the catching unit 120 and inserted into the first latch unit 100.

The catching portion 124 is formed at one side of the accommodating groove 122 and has a hook shape. Here, one side of the accommodating groove 122 means a direction close to the striker unit 220, as illustrated in FIGS. 2 and 3.

The weight portion 126 is formed at the other side of the accommodating groove 122 and has a heavier weight than the catching portion 124. Here, the other side of the accommodating groove 122 means a direction distant from the striker unit 220, as illustrated in FIGS. 2 and 3.

As described above, the accommodating groove 122, the catching portion 124, and the weight portion 126 of the catching unit 120 are rotated about the catching unit rotating shaft 121. When no external force is applied to the catching unit 120, the weight portion 126 is disposed at a lower side due to a weight thereof, and the accommodating groove 122 and the catching portion 124 are tilted toward the striker unit 220.

A striker unit damper 150 is positioned at one side of the catching unit 120 so that the striker unit 220 is seated on the striker unit damper iso. The striker unit damper 150 restricts a movement of the striker unit 220 inserted into the first latch unit 100, thereby reducing noise occurring when the striker unit 220 moves. The striker unit damper 150 may be made of an elastic material such as rubber, but the material of the striker unit damper 150 is not restricted.

As illustrated in FIG. 3, the pawl unit 130 is connected to the first plate no so as to be rotatable about a pawl unit rotating shaft 131 and positioned at a lower side of the catching unit 120. Here, the pawl unit rotating shaft 131 is fixedly connected to the first plate 110. A catching protrusion 133 is formed at one end of the pawl unit 130, and the pawl unit rotating shaft 131 is inserted at the other end of the pawl unit 130. Here, the catching protrusion 133 may be in contact with one end of a second release lever 240 to be described below.

The pawl unit 130 has a catching/corresponding portion 134. The catching/corresponding portion 134 has a hook shape corresponding to the shape of the catching portion 124 of the catching unit 120 and may be brought into contact with the catching portion 124 and released from the catching portion 124. Therefore, a rotation of the catching unit 120 is restricted when the catching portion 124 and the catching/corresponding portion 134 are in contact with each other, and the catching unit 120 is rotated when the catching portion 124 and the catching/corresponding portion 134 are not in contact with each other.

A pawl unit damper 136 is positioned at one side of the pawl unit 130. The pawl unit damper 136 restricts a motion of the pawl unit 130 so that the pawl unit 130 is rotated within a predetermined range, thereby reducing noise occurring when the pawl unit 130 moves. The pawl unit damper 136 may be made of an elastic material such as rubber, but the material of the pawl unit damper 136 is not restricted.

One end of the first release lever 140 is rotatably connected to the pawl unit rotating shaft 131 in a direction opposite to the pawl unit 130. A return spring R is positioned between the pawl unit rotating shaft 131 and the first release lever 140, and the return spring R provides elastic force to assist in rotating the pawl unit 130 and the first release lever 140 together when the pawl unit 130 and the first release lever 140 are rotated.

Specifically, when external force is applied, the return spring R provides elastic force to assist in rotating the pawl unit 130 and the first release lever 140 together in one direction. On the contrary, when the external force is eliminated, the pawl unit 130 and the first release lever 140 are rotated together in the reverse direction by elastic restoring force from the return spring R.

Meanwhile, as illustrated in FIG. 3, the pawl unit 130 and the first release lever 140 may be connected to each other through the pawl unit rotating shaft 131 with a body 160 interposed therebetween. That is, the return spring R and the first release lever 140 are positioned at one side of the body 160, the pawl unit 130 is positioned opposite to the body 160, and the pawl unit rotating shaft 131 penetrates the body 160, such that the pawl unit 130 and the first release lever 140 are connected to each other.

The first release lever 140 is rotated about the pawl unit rotating shaft 131 and includes a movement restricting groove 142 to limit the rotational region of the first release lever 140 to a predetermined range. The movement restricting groove 142 accommodates a movement restricting protrusion 144 fixedly connected to the first plate 110, such that the motion of the first release lever 140 is restricted within a region of the movement restricting groove 142.

A cable C is connected to an opposite end of the first release lever 140. Therefore, when the cable C is rectilinearly moved, the first release lever 140 rotates about the pawl unit rotating shaft 131. Here, the cable C is accommodated in a first cable unit 170 positioned at one side of the first plate 110, and the cable C is extended to the outside through a first cable outlet 172. The rectilinear motion of the cable C may be automatically performed by a winding unit such as a motor connected to the cable C and by a controller configured to control the winding unit.

Meanwhile, in the exemplary embodiment of the present invention, a housing 180 is provided to accommodate the first plate no and the components connected to the first plate 110. A housing insertion groove 182, which corresponds to the shape of the plate insertion groove 112, is formed at one side of the housing 180.

The second latch unit 200 includes a second plate 210 having a bracket portion so as to be mounted on the second door 20, and the striker unit 220 connected to the second plate 210, and the second release lever 240.

As illustrated in FIG. 6, the striker unit 220 is fixedly connected to the second plate 210 and has a loop shape directed toward the first latch unit 100. The catching portion 124 of the catching unit 120 may be inserted into or extended from the loop of the striker unit 220.

As illustrated in FIG. 5, the second release lever 240 is connected to the second plate 210 so as to be rotatable about a lever rotating shaft 241. Here, the lever rotating shaft 241 is fixedly connected to the second plate 210. A return spring R′ is positioned between the lever rotating shaft 241 and the second release lever 240, and the return spring R′ provides elastic force to assist in rotating the second release lever 240.

Specifically, when external force is applied, the return spring R′ provides elastic force to assist in preventing a rapid motion of the second release lever 240 while the second release lever 240 rotates in one direction. On the contrary, when the external force is eliminated, elastic restoring force of the return spring R′ assists in rotating the second release lever 240 in the reverse direction.

One end of the second release lever 240 may be in contact with the catching protrusion 133 of the pawl unit 130 in the state in which the first and second doors 10 and 20 are closed. In the exemplary embodiment of the present invention, one end of the second release lever 240 is positioned at an upper side of the catching protrusion 133.

The cable C is connected to the opposite end of the second release lever 240.

Therefore, when the cable C is rectilinearly moved, the second release lever 240 rotates about the lever rotating shaft 241. Here, the cable C is accommodated in a second cable unit 270 positioned at one side of the second plate 210, and the cable C is extended to the outside through a second cable outlet 272. The rectilinear motion of the cable C may be automatically performed by the winding unit such as a motor connected to the cable C and by the controller configured to control the winding unit.

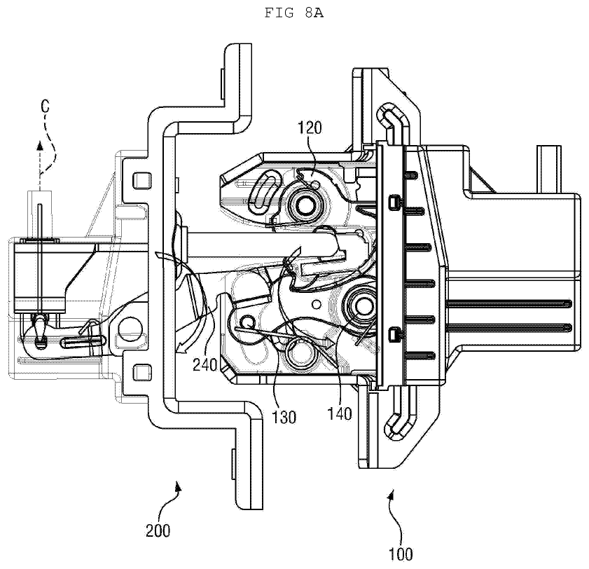

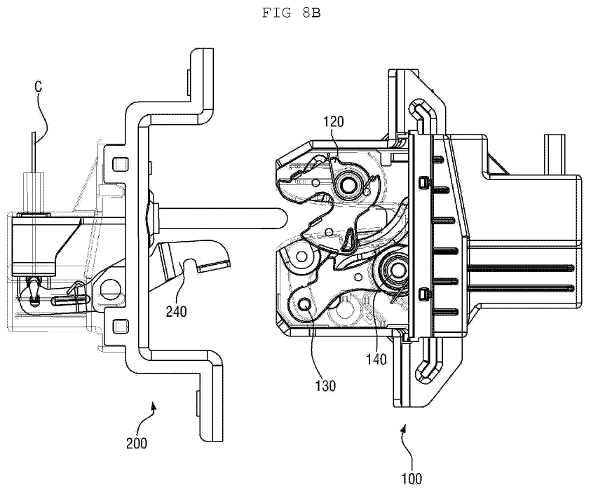

FIG. 7A is a view illustrating an operation of releasing the locking device by pulling the cable connected to the first latch unit, FIG. 7B is a view illustrating a state in which the first latch unit and the second latch unit are separated from each other after the locking device is released, FIG. 8A is a view illustrating an operation of releasing the locking device by pulling the cable connected to the second latch unit, and FIG. 8B is a view illustrating a state in which the first latch unit and the second latch unit are separated from each other after the locking device is released.

Hereinafter, an operating process of the locking device having no restriction on order of opening or closing doors according to the exemplary embodiment of the present invention will be described with reference to FIGS. 7A, 7B, 8A, and 8B.

According to the locking device having no restriction on order of opening or closing doors according to the exemplary embodiment of the present invention, the first door 10 or the second door 20 is opened as one of the first and second latch units 100 and 200 is operated in the state in which the first and second doors 10 and 20 are closed, and as a result, there is no restriction on the order of opening or closing the doors.

In the state in which the first and second doors 10 and 20 are closed, the striker unit 220 is inserted into the plate insertion groove 112 of the first plate no, and the catching portion 124 of the catching unit 120 is inserted into the loop of the striker unit 220. Further, the catching unit 120 cannot be rotated because the catching portion 124 is in contact with the catching/corresponding portion 134 of the pawl unit 130. As a result, the first and second doors 10 and 20 are fastened to each other because the first and second latch units 100 and 200 are connected to each other.

First, a process of opening the first door 10 or the second door 20 by the operation of the first latch unit 100 will be described.

As illustrated in FIG. 7A, when the cable C is rectilinearly moved upward, the first release lever 140 and the pawl unit 130 connected to the first release lever 140 are rotated counterclockwise. Here, a rapid motion of the pawl unit 130 is prevented by the elastic force of the return spring R inserted into the pawl unit rotating shaft 131.

When the pawl unit 130 moves downward while rotating counterclockwise, the contact between the catching/corresponding portion 134 and the catching portion 124 is released, and the catching unit 120 is rotated clockwise by gravity of the weight portion 126, such that the catching portion 124 is extended to the outside of the loop of the striker unit 220. Then, the first and second latch units 100 and 200 are disconnected. Therefore, as illustrated in FIG. 7B, the first door 10 or the second door 20 may be opened.

Next, a process of opening the first door 10 or the second door 20 by the operation of the second latch unit 200 will be described.

As illustrated in FIG. 8A, when the cable C is rectilinearly moved upward, the second release lever 240 is rotated clockwise. Here, a rapid motion of the second release lever 240 is prevented by the elastic force of the return spring R inserted into the lever rotating shaft 241.

The rotating second release lever 240 rotates the pawl unit 130 counterclockwise by being caught by the catching protrusion 133. In this case, the contact between the catching/corresponding portion 134 and the catching portion 124 is released as the pawl unit 130 moves downward, and the catching portion 124 is extended to the outside of the loop of the striker unit 220 as the catching unit 120 is rotated clockwise by gravity of the weight portion 126. Then, the first and second latch units 100 and 200 are disconnected. Therefore, as illustrated in FIG. 8B, the first door 10 or the second door 20 may be opened.

The locking device having no restriction on order of opening or closing doors according to the exemplary embodiment of the present invention locks or unlocks the first and second doors 10 and 20 connected to the vehicle body.

The first and second doors 10 and 20, which are in the locked and closed state, are unlocked as the first latch unit 100 or the second latch unit 200 is operated. In this case, any one of the first and second doors 10 and 20 may be opened first, and this means that the first and second doors 10 and 20 may be opened simultaneously.

Any one of the first and second doors 10 and 20, which are in the unlocked and opened state, may be closed first, and this means that the first and second doors 10 and 20 may be closed simultaneously. When the first and second doors 10 and 20 are closed, the first and second latch units 100 and 200 are fastened to each other.

The present invention has been described with reference to the limited exemplary embodiments and the drawings, but the present invention is not limited thereto. The described exemplary embodiments may be variously changed or modified by those skilled in the art to which the present invention pertains within the technical spirit of the present invention and within the scope equivalent to the appended claims.

What is claimed is:

1. A locking device having no restriction on order of opening or closing doors, which is capable of locking or unlocking first and second doors connected to a vehicle body, and opening any one of the first and second doors first in a state in which the doors are closed and locked or closing any one of the first and second doors first in a state in which the doors are unlocked and opened, the locking device comprising:
a first latch unit that includes a catching unit positioned at a lateral side of the first door and rotatably coupled to a first plate, a pawl unit rotatably coupled to the first plate to rotate the catching unit or restrict rotation of the catching unit, and a first release lever configured to assist in rotating the pawl unit about a rotating shaft for the pawl unit; and
a second latch unit positioned at a lateral side of the second door so as to face the first latch unit, the second latch unit including a second release lever rotatably coupled to a second plate, and a striker unit configured to be caught by or released from the rotating catching unit.

2. The locking device of claim 1, wherein the catching unit includes an accommodating groove configured to accommodate the striker unit, a catching portion formed at one side of the accommodating groove and configured to be caught by the pawl unit to restrict the rotation of the catching unit, and a weight portion formed at the other side of the accommodating groove and configured to assist in rotating the catching unit.

3. The locking device of claim 2, wherein the pawl unit includes a catching/corresponding portion having a shape corresponding to a shape of the catching portion.

4. The locking device of claim 1, wherein one end of the second release lever and one end of the pawl unit, which are in contact with each other, are rotatable in opposite directions.

5. The locking device of claim 1, wherein a catching protrusion, which is in contact with the second release lever, is formed at one end of the pawl unit.

6. The locking device of claim 1, wherein a return spring is positioned on the rotating shaft for the pawl unit, the return spring configured to provide elastic force so that the pawl unit and the first release lever, which are in a connected state, are rotated in one direction when external force is applied, and the return spring is configured to provide elastic elastic restoring force so that the pawl unit and the first release lever are rotated in a reverse direction when the external force is eliminated.

7. The locking device of claim 1, wherein a movement restricting protrusion is formed on the first plate and wherein a movement restricting groove configured to accommodate the movement restricting protrusion is formed in the first release lever.

8. The locking device of claim 1, further comprising a cable connected to the first release lever or the second release lever.

9. The locking device of claim 1, further comprising a striker unit damper positioned at one side of the catching unit, the striker unit damper configured to allow the striker unit to be seated thereon to restrict a movement of the striker unit and reduce noise occurring when the striker unit moves.

10. The locking device of claim 1, further comprising a pawl unit damper configured to restrict a movement of the pawl unit and reduce noise occurring when the pawl unit moves, the pawl unit damper being provided at one side of the pawl unit.

11. A vehicle comprising:
a vehicle body;
a first door connected to a first side of the vehicle body;
a second door connected to the first side of the vehicle body;
a first latch unit that includes a catching unit positioned at a lateral side of the first door and rotatably coupled to a first plate, a pawl unit rotatably coupled to the first plate to rotate the catching unit or restrict rotation of the catching unit, and a first release lever configured to assist in rotating the pawl unit about a rotating shaft for the pawl unit; and
a second latch unit positioned at a lateral side of the second door so as to face the first latch unit, the second latch unit including a second release lever rotatably coupled to a second plate, and a striker unit configured to be caught by or released from the rotating catching unit.

12. The vehicle of claim 11, wherein the catching unit includes an accommodating groove configured to accommodate the striker unit, a catching portion formed at one side of the accommodating groove and configured to be caught by the pawl unit to restrict the rotation of the catching unit, and a weight portion formed at the other side of the accommodating groove and configured to assist in rotating the catching unit.

13. The vehicle of claim 12, wherein the pawl unit includes a catching/corresponding portion having a shape corresponding to a shape of the catching portion.

14. The vehicle of claim 11, wherein one end of the second release lever and one end of the pawl unit, which are in contact with each other, are rotatable in opposite directions.

15. The vehicle of claim 11, wherein a catching protrusion, which is in contact with the second release lever, is formed at one end of the pawl unit.

16. The vehicle of claim 11, wherein a return spring is positioned on the rotating shaft for the pawl unit, the return spring configured to provide elastic force so that the pawl unit and the first release lever, which are in a connected state, are rotated in one direction when external force is applied, and the return spring is configured to provide elastic restoring force so that the pawl unit and the first release lever are rotated in a reverse direction when the external force is eliminated.

17. The vehicle of claim 11, wherein a movement restricting protrusion is formed on the first plate and wherein a movement restricting groove configured to accommodate the movement restricting protrusion is formed in the first release lever.

18. The vehicle of claim 11, further comprising a cable connected to the first release lever or the second release lever.

19. The vehicle of claim 11, further comprising a striker unit damper positioned at one side of the catching unit, the striker unit damper configured to allow the striker unit to be seated thereon to restrict a movement of the striker unit and reduce noise occurring when the striker unit moves.

20. The vehicle of claim 11, further comprising a pawl unit damper configured to restrict a movement of the pawl unit and reduce noise occurring when the pawl unit moves, the pawl unit damper being provided at one side of the pawl unit.
